(19) United States
(12) Patent Application Publication
(10) Pub. No.: US 2012/0305824 A1
(43) Pub. Date: Dec. 6, 2012

(54) Valve Device Having a Valve Closing Member Guided by Means of a Cardan Joint

(75) Inventors: Otto VOLLMER, Muenchen (DE); Daniel MANN, Muenchen (DE)

(73) Assignee: KNORR-BREMSE Systeme fuer Nutzfahrzeuge GmbH, Muenchen (DE)

(21) Appl. No.: 13/532,361

(22) Filed: Jun. 25, 2012

Related U.S. Application Data
(63) Continuation of application No. PCT/EP2010/069836, filed on Dec. 15, 2010.

(30) Foreign Application Priority Data
Dec. 23, 2009 (DE) 10 2009 060 184.8

(51) Int. Cl. F16K 1/42

(52) U.S. Cl. 251/359

(57) ABSTRACT

A valve device of a device of a vehicle, actuated by a pressure medium has at least one valve closing member that can be brought by a valve member into an open or a closed position with respect to a valve seat for releasing or closing a flow cross section for the pressure medium. The valve closing member is connected to the valve member by at least one Cardan joint, such that the valve closing member can pivot spatially relative to the valve member.

### CROSS-REFERENCE TO RELATED APPLICATIONS

This application is a continuation of PCT International Application No. PCT/EP2010/069836, filed Dec. 15, 2010, which claims priority under 35 U.S.C. §119 from German Patent Application No. DE 10 2009 060 184.8, filed Dec. 23, 2009, the entire disclosures of which are herein expressly incorporated by reference.

### BACKGROUND AND SUMMARY OF THE INVENTION

The invention relates to a valve device of a device of a vehicle, actuated by a pressure medium, having at least one valve closing member, which can be brought by a valve member into an open or a closed position with respect to a valve seat in order to release or close a flow cross section for the pressure medium.

A valve device of the type in question for controlling the brake pressure in pneumatic brake systems of vehicles is known from EP 0 304 610 B1 and has an electromagnetic control valve for an inlet valve and an electromagnetic control valve for an outlet valve. The electromagnetic control valves each have a cylindrical valve member in the form of an armature, which can be moved with respect to two opposing valve seats in accordance with the energization of an electromagnet. At the ends, the armature has formed on it a valve closing member which interacts with, in each case, one valve seat, which, at one end, is formed by an elastomer surface and, at the other end, is formed by a spherical surface.

The force which must be applied by the electromagnet to ensure that the valve closing members are pressed in a leak tight manner against the associated valve seats depends very much on whether the valve closing members can rest uniformly on the valve seats as viewed in the circumferential direction of the valve seats. This is not always assured since customary tolerances can lead to geometrical deviations on the valve closing member and/or on the associated valve seat. A larger actuating force than that for ideal geometrical conditions is then necessary in order to produce reliable sealing at the valve seat. The higher force is necessary especially in order to produce sealing contact over the entire circumference when there is initially contact between the valve closing member and the valve seat on only one side owing to axial misalignment, a situation in which the valve closing member and/or the valve seat are deformed.

This is disadvantageous, on the one hand, because these deformations give rise to unwanted wear on the valve closing bodies and/or on the valve seats. On the other hand, a higher actuating force on the valve members to close the flow cross sections entails not only higher energy consumption but also less sensitive open-loop or closed-loop control of the valve device, this being reflected in greater hysteresis. This behavior is disadvantageous, especially in respect of vehicle brake systems, which have a bearing on safety, because the control dynamics, in the context of ABS, ASR or ESP, for example, are then impaired. In the case of relatively large tolerances, there may then even be leaks in the closed position of the valves.

Given this situation, it is the underlying object of the present invention to further develop a valve device of the above-mentioned type in such a way that the disadvantages described above are avoided.

According to the invention, this and other objects are achieved by a valve device of a device of a vehicle, actuated by a pressure medium, having at least one valve closing member, which can be brought by a valve member into an open or a closed position with respect to a valve seat in order to release or close a flow cross section for the pressure medium. The valve closing member is connected to the valve member by at least one Cardan joint such that the valve closing member is pivotable in three dimensions relative to the valve member.

The invention therefore proposes that the valve closing member be connected to the valve member by at least one Cardan joint in such a way that the valve closing member can be pivoted in three dimensions relative to the valve member.

As is known, a genuine Cardan joint of this kind has one fork associated with the valve member and another fork associated with the valve closing member, wherein one fork is arranged offset by 90 degrees relative to the other fork, in relation to a center line, and connected rotatably by use of a cross-pin.

By virtue of the three-dimensional pivotability of the valve closing member directly interacting with the valve seat relative to the valve member, which is a piston or an armature of the valve, for example, it is possible to compensate for even relatively large geometrical errors, in particular relatively large axial and angular misalignments of the valve closing member and of the valve member.

This measure entails a number of advantages over the prior art. On the one hand, it leads to cost savings because the valve seats, the valve members and/or the valve closing members can be embodied with larger tolerances. On the other hand, the stress on the valve seats and the valve closing members through deformation is reduced because the valve closing members can align themselves freely relative to the valve seats. This applies particularly to flexible valve closing members made of polymers. As a result, the leaktightness of the valves is simultaneously improved, especially at low temperatures. Moreover, the hysteresis of the valves is reduced.

Compared with ball joints, which would also be contemplated for the pivotable connection of the valve closing member to the valve member, Cardan joints have the advantage that they can compensate for deviations more sensitively owing to a lower adjusting torque because the diameter of a cross-pin of a Cardan joint is smaller than the diameter of a ball joint, which is always larger. Moreover, the outlay on production is lower than that for a ball joint because, for example, standardized pins can be used and larger tolerances can be permitted. This is because the matching of the ball and the ball shell is relatively involved in the case of a ball joint.

In a particularly preferred embodiment, the valve seat and/or the valve closing member is/are provided with a flexible sealing surface on the operative surface thereof facing the valve seat in order, on the one hand, to increase the sealing effect and, on the other hand, to allow additional compensation of relatively small geometrical errors.

According to a further development, the valve member is designed as a pneumatically actuable piston of a pneumatic valve. As an alternative, the valve member could be formed by an armature of an electromagnetic valve, wherein the valve closing member is then connected pivotably to the piston or the armature by way of the Cardan joint.

In a particularly preferred embodiment, the valve device forms a pneumatic, hydraulic, electropneumatic or electrohydraulic valve of a brake system or of a pneumatic suspension device of a vehicle, on which the invention is formed.

Other objects, advantages and novel features of the present invention will become apparent from the following detailed description of one or more preferred embodiments when considered in conjunction with the accompanying drawing.

### BRIEF DESCRIPTION OF THE DRAWING

The single FIGURE shows a cross-sectional representation of a valve of a brake system of a vehicle in accordance with a preferred embodiment of the invention.

### DETAILED DESCRIPTION OF THE DRAWING

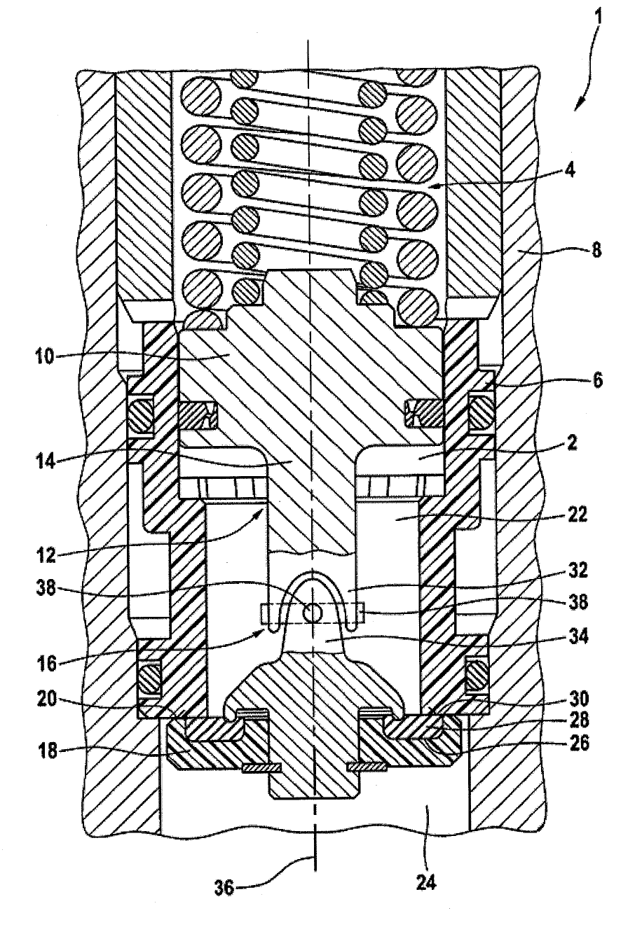

The valve 1 shown in cross section in FIG. 1 is a pneumatic 2/2-way valve of a pneumatic braking device on a commercial vehicle, for example.

The valve 1 has as a valve member a piston 10, which can be actuated by the pressure force of an air pressure prevailing in a pressure chamber 2 against the action of a preloading spring device 4 and is guided in a linear manner in a guide bush 6 in the valve housing 8. At the end of the piston 10 remote from the preloading spring device 4, where the piston rod 14 projects through an opening 12 in the guide bush 6, this piston 10 is connected to a valve closing member 18 by way of a Cardan joint 16, allowing the valve closing member 18 to pivot in all directions.

The valve closing member 18 is plate-shaped, for example, and interacts in such a way with a valve seat 20 formed on the end of the guide bush 6 that, when the valve closing member 18 is resting in a leak tight manner on the valve seat 20 in the context of a valve closing position, a flow between a working space 22 and a valve outlet 24 is prevented. In the context of a valve opening position, when the valve closing member 18 is raised from the valve seat 20, any desired flow cross section between a minimum and a maximum is opened between the working space 22 and the valve outlet 24.

In a particularly preferred embodiment, the valve closing member 18 has on the surface thereof facing the valve seat 20 an annular recess 26, in which a flexible ring 28 made, for example, of an elastomer, is held. This ring 28 then interacts with a complementary sealing surface 30 on the valve seat 20.

By supplying the pressure chamber 2 with pressure or relieving pressure from the pressure chamber 2, it is possible to produce the valve closing position and the valve opening position, respectively.

The Cardan joint 16 has one fork 32 associated with the piston rod 14 and another fork 34 associated with the valve closing member 18, wherein one fork 32 is offset, preferably by 90 degrees, relative to the other fork 34, in relation to a center line 36, and connected rotatably by use of a cross-pin 38. However, other versions of Cardan joint 16 may also be used.

By virtue of the Cardan joint 16, the valve closing member 18 can be pivoted on all sides relative to the piston 10, i.e. spatially in all directions, thereby making it possible to compensate for geometrical errors between the valve closing member 18 and/or the valve seat 20 and/or the valve member (piston) 10.

The invention is not restricted to the valve described above but is suitable for any type of valve in which a valve closing member interacts with a valve seat under certain geometrical conditions.

### LIST OF REFERENCE NUMERALS

1 valve

2 pressure chamber

4 preloading spring device

6 guide bush

8 valve housing

10 piston

12 opening

14 piston rod

16 Cardan joint

18 valve closing member

20 valve seat

22 working space

24 valve outlet

26 annular recess

28 ring

30 sealing surface

32 fork

34 fork

36 center line

38 cross-pin

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A valve device in a vehicle, the valve device comprising:
a valve closing member;
a valve seat;
a valve member operatively configured to move the valve closing member into an open or a closed position with respect to the valve seat in order to release or close a flow cross-section for a pressure medium;
a Cardan joint coupling the valve closing member to the valve member, wherein the valve closing member is pivotable in three dimensions relative to the valve member.

2. The valve device according to claim 1, wherein:
the Cardan joint has one fork associated with the valve member and another fork associated with the valve closing member,
one fork is arranged offset by 90 degrees relative to the other fork in relation to a center line and is connected rotatably via a cross-pin.

3. The valve device according to claim 1, further comprising a flexible sealing surface arranged on at least one of the valve seat and the valve closing member.

4. The valve device according to claim 3, wherein the flexible sealing surface is on an operative surface of the valve closing member facing the valve seat.

5. The valve device according to claim 2, further comprising a flexible sealing surface arranged on at least one of the valve seat and the valve closing member.

6. The valve device according to claim 1, wherein the valve member comprises a pneumatically actuatable piston of a pneumatic valve.

7. The valve device according to claim 2, wherein the valve member comprises a pneumatically actuatable piston of a pneumatic valve.

8. The valve device according to claim 3, wherein the valve member comprises a pneumatically actuatable piston of a pneumatic valve.

9. The valve device according to claim 1, wherein the valve device is one of a pneumatic, hydraulic, electropneumatic, and electrohydraulic valve of a brake system of the vehicle.

10. The valve device according to claim 1, wherein the valve is one of a pneumatic, hydraulic, electropneumatic, and electrohydraulic valve of a pneumatic suspension component of the vehicle.
